(19) United States
(12) Patent Application Publication
(10) Pub. No.: US 2006/0171160 A1
(43) Pub. Date: Aug. 3, 2006

(54) Verticalised headlight for a motor vehicle

(76) Inventors: Jean-Luc Meyrenaud, Bobigny (FR); Etienne Pauty, Bobigny (FR)

Correspondence Address: MORGAN & FINNEGAN, L.L.P., 3 WORLD FINANCIAL CENTER, NEW YORK, NY, 10281-2101, US

(21) Appl. No.: 11/346,423

(22) Filed: Feb. 1, 2006

(30) Foreign Application Priority Data
Feb. 1, 2005 (FR) 05 01 035

(51) Int. Cl. F21V 7/00

(52) U.S. Cl. 362/517; 362/539; 362/538; 362/245; 362/346; 362/328

(57) ABSTRACT

A lighting device for a motor vehicle of the headlight type comprising at least one reflector and one light source, with (a) a first light source with a direct shield placed in the vicinity of and in front of the internal focus of an ellipsoidal reflector, in particular so that the axis of the source is substantially parallel to the optical axis of the ellipsoidal reflector, this reflector being designed to produce a first beam from the first source, (b) a second light source placed in the vicinity of and behind the internal focus of the said ellipsoidal reflector, in particular so that the axis of the source is substantially parallel to the optical axis of the ellipsoidal reflector, (c) the wall of the ellipsoidal reflector comprises a cut out situated on one side of a plane, in particular a plane that is substantially horizontal when the device is in the mounted position in the vehicle, (d) a lens with the optical axis substantially parallel to or merged with that of the ellipsoidal reflector is placed in front of this reflector, the focus of the lens being adjacent to the external focus of the ellipsoidal reflector, and (e) a verticalised reflector disposed on the side of the cut out opposite to the major part of the ellipsoidal reflector, this verticalised reflector being designed to produce, from the second source housed in the ellipsoidal reflector, a second light beam which is not substantially intercepted by the lens.

### BACKGROUND OF THE INVENTION

The invention relates to a headlight for a motor vehicle, in particular headlight of the so-called “verticalised” type and comprising at least one reflector associated with at least one light source preferably placed in the vicinity of the focus of the reflector. This term means, within the meaning of the invention, a headlight which, once mounted on the vehicle for which it is intended, has a height with a dimension significantly greater than its width. It is a headlight which extends principally in a vertical direction once mounted and which is therefore significantly higher than wide (even if it may be mounted in a fashion that is not exactly vertical in the body of the vehicle). This verticalisation is generally caused by the arrangement of the reflector of the headlight (of the main headlight if there are several of them), itself also disposed in the headlight so as to be higher than wide once on the vehicle. These so called “verticalised” headlights are advantageous, first because they offer new possibilities in terms of optical performance, and then because this confers an original style on them.

There is known from the patent EP 0 933 585 a headlight with a light source disposed transversely to the optical axis of the reflector with which it is associated, this reflector being of the “verticalised” type. As already explained above, the expression “verticalised” reflector means a reflector extending principally in the vertical direction once the headlight is mounted in the vehicle, and whose surface is determined so as to reflect, in a substantially horizontal direction, light rays coming from a source situated in the vicinity of the focus of the reflector. The headlight according to the patent EP 0 933 585 makes it possible to obtain a beam with a satisfactory range along the optical axis of the headlight, with a sharp cut-off of the beam below a horizontal plane. There is also known from the patent EP 1 433 999 a verticalised headlight comprising a light source disposed transversely to the optical axis of an ellipsoidal reflector, the wall of which comprises a cut out. A lens is placed in front of the ellipsoidal reflector, and a verticalised reflector is disposed on the side of the cut out opposite to the ellipsoidal reflector. This verticalised reflector is designed to produce, from the source housed in the ellipsoidal reflector, a light beam which is not intercepted by the lens. It has turned out however that this optical system could be improved further.

### SUMMARY AND OBJECTS OF THE INVENTION

The aim of the invention is therefore to provide a headlight intended to equip vehicles which, whilst keeping the advantages procured by a headlight with a verticalised reflector, makes it possible to obtain better optical performance, in particular to obtain a system able to produce several beams with different beam patterns with the same optical system. Secondarily, the invention seeks to obtain a headlight of the verticalised type which can be of compact dimensions, in particular with regard to its depth, and which is simple in operation.

The object of the invention is a lighting device for a motor vehicle of the headlight type comprising at least one reflector and one light source and able to emit several different light beams, such that:
a first light source with a shield S1 is placed in the vicinity of and in front of the internal focus Fi of an ellipsoidal reflector R1, in particular so that the axis of the source is substantially parallel to the optical axis (YY) of the ellipsoidal reflector R1, this reflector R1 being designed to produce a first beam from the first source S1, (a shield being here an element or a group of elements that intercepts part of the light emitted directly by the light source, notably a component associated to the light source, also called cupola). The “ellipsoidal” type of the reflector is to be understood in the common meaning in the vehicle headlamp industry, and it has not a strictly ellipsoid shape in the theoretical, optical meaning. This remark applies also to all the terms used in the present text like ellipsoidal, parabolic, etc.
a second light source S2 is placed in the vicinity of and behind the internal focus Fi of the said ellipsoidal reflector R1, in particular so that the axis of the source is substantially parallel to the optical axis (YY) of the ellipsoidal reflector R1,
the wall of the ellipsoidal reflector R1 comprises a cut out 1 situated on one side of a plane, in particular a plane that is substantially horizontal when the device is in the mounted position in the vehicle (this plane can pass through the geometric axis of the first light source S1 and/or be substantially parallel to the optical axis (Y-Y) of the ellipsoidal reflector R1), said cut out could also be understood as notch or indentation, and examples will be illustrated in the figures.
a lens 2 with the optical axis substantially parallel to or merged with that of the ellipsoidal reflector R1 is placed in front of this reflector R1, the focus 3 of the lens being adjacent to the external focus Fe of the ellipsoidal reflector,
a verticalised reflector R2 is disposed on the side of the cut out 1 opposite to the major part of the ellipsoidal reflector R1, this verticalised reflector R2 being designed to produce, from the second source S2 housed in the ellipsoidal reflector R1, a second light beam which is not substantially intercepted by the lens 2.

This verticalised reflector R2 preferably comprises at least three zones disposed successively along the height of the said reflector: a first zone R21 closest to the cut out (1), which is an ellipsoidal surface portion, then a second zone R22 composed of a plurality of facets, and then a third zone R23 which is a portion of a parabolic surface.

“Source” means the filament or filaments of the lamp when it is acting as a filament lamp of the halogen lamp type (which is commonly assimilated to a cylinder). “Direct shield,” also referred to as a “cupola” or “baffle”, means the component or element disposed close to the light source in question (here the first light source S1) which recovers part of the light emitted directly by the source in order to redirect it in another direction towards another zone. It is generally an element whose surface directed towards the source is reflective and which is situated in the immediate vicinity of the source inside the bulb of the lamp. Usually the baffles integrated into the lamps are known for serving to create the cut-off of a beam with cut-off of the dipped type. In the invention, it is preferred to use this baffle in order to prevent the light emitted by the first source being able to reach the verticalised reflector. The baffle is therefore used firstly as a means of obscuring the rays coming from the first source S1 towards the verticalised reflector R2. As this means is preferably reflective vis-a-vis these rays and non-absorbent, it will also serve as a flux recoverer of the rays from S1 towards the reflector R1.

The invention has thus designed a lighting device for a vehicle which associates two types of reflector: an ellipsoidal reflector associated with a lens of the type that is found for example in elliptical modules, and a verticalised reflector, preferably sharing the same focus. The ellipsoidal reflector will therefore be able to cooperate with the first source and the lens in order to give a first type of beam, in particular with cut-off, whilst the verticalised reflector can cooperate with the second source in order to produce a completely different beam, a beam without cut-off of the main beam type for example. The optical system according to the invention can thus constitute a dual-function module of the dipped/main beam type which is compact and which does not require any movable part in order to change from one function to another. Each reflector has therefore been “specialized”, associated with “its” light source, which makes it possible to adjust the two different beams very precisely from the same module.

It should be noted incidentally that an orientation of the light sources substantially parallel to the optical axis has the advantage of an identical mounting of the light source between the right-hand headlight and the left-hand headlight of the same vehicle.

Preferably, the two light sources S1, S2 are combined according to the invention in a single lamp of the dual-filament type: this is a compact solution which requires making only one opening in order to mount the single lamp in the ellipsoidal reflector. It may be a case for example of lamps known by the trade name H4 or DFCS.

Preferably, the axis of at least one of the light sources S1, S2 in particular of the two sources, is disposed in a substantially horizontal plane.

Preferably, all the zones of the verticalised reflector R2 have a focus situated in the vicinity of the second light source S2.

Advantageously, the first zone R21 of the verticalised reflector R2 is an ellipsoidal surface focussed on the second light source S2. This zone contributes in particular to increasing the comfort of the second beam. “Comfort” means the intermediate light area that is situated between the maximum point of illumination of the light beam and the most lateral zones of the beam which define its width.

Advantageously, the second zone R22 of the verticalised reflector comprises at least one central facet (z1), at least two intermediate facets z2 and at least two lateral facets z3. There can thus be one and preferably two central facets which contribute in particular to the width of the second beam, at least two or four intermediate facets which contribute in particular to the comfort of the second beam, and finally two or four lateral facets which contribute more to the maximum of the second beam. The greater the number of facets, the more a good standard of homogeneity of the beam is guaranteed but on the other hand the more complex the design of the reflector. A total number of facets between six and twelve can be considered satisfactory. The facets can be delimited from each other by serrations or not.

Advantageously, the third zone R23 contributes to defining the maximum of the beam produced by the whole of the verticalised reflector R2.

According to one embodiment of the invention, the ellipsoidal reflector R1) comprises a shield 5 situated in the vicinity of the external focus Fe of the reflector R1 so that the beam coming from the said reflector R1 and emitted by the said device is a beam with cut-off, in particular of the dipped beam type. The shield can be situated at the focus or at the rear of the focus of the ellipsoidal reflector. The top edge of the shield is preferably situated below the horizontal plane passing through the optical axis of the reflector, in particular between 0 and 2 mm below, especially between 0.5 and 1.8 mm or between 0.7 and 1.7 mm below, for example approximately 1.5 mm below. The choice of this dimension depends on the definition of the ellipsoidal mirror. This arrangement of the shield is advantageous since it makes it possible to recover a portion of the supplementary light flux that is not a nuisance. Here, the term “shield” is to be understood as able to intercept part of the light both emitted directly by the light source and indirectly though reflection(s) on the reflector.

The shield can consist of a portion of a cylinder with vertical generatrices, turning its concavity towards the front, according to the curvature of the field of the ellipsoidal reflector. The shield can also have other geometric definitions, for example be planar. The choice of its shape can depend on the chromatics of the lens associated with the ellipsoidal mirror.

The radius of the cylinder portion can thus vary by a value R=x is equal to 15 or 30 mm, with R=infinity according to the field curvature.

Optionally, the shield is associated with an additional optical element disposed between the light source and the shield, the said additional optical element being in the vicinity of the optically active edge of the shield and having at least one reflective surface able to redirect, above the optically active edge of the shield, light rays emitted by the source in the direction of the said shield.

This additional element can take the form of a plate, the front edge of which is up against the optically active edge of the shield, which is substantially planar and one face of which turned upwards is reflective. This element can be fixed mechanically to the shield, or can form an integral part of it. This element can be designated by the term “bender”. This bender is designed so that it returns the rays towards the lens in an appropriate fashion, rays which otherwise would have been lost.

The lens can be disposed so that its focus is situated at the rear, in particular at the same level as the top edge of the shield when present, for example at approximately 0.5 to 2 mm to the rear, for example 1.5 mm to the rear of the external focus of the ellipsoidal reflector. This distance can depend in particular on the focal length of the lens and on the definition of the ellipsoid. (The focus of the lens can also be situated exactly at the external focus.) This configuration of the lens at the rear of the external focus makes it possible to optimise the recovery of the maximum light flux above the cut-off when there is a shield.

Preferably, the second beam coming from the second source S2 and reflected by the verticalised reflector R2, possibly with a contribution from the ellipsoidal reflector (R1), is a beam without cut-off, of the main beam type.

The beam produced by the verticalised reflector preferably has an beam angle of no more than or around ±15° on each side of the optical axis. The beam produced by the ellipsoidal reflector has an beam angle of approximately ±35° to 45° on each side of the optical axis.

Generally the plane passing through the axis of the first light source S1 is substantially horizontal, the ellipsoidal reflector R1 being situated above this plane and the verticalised reflector R2 being situated below this plane.

The cut out 1 in the ellipsoidal reflector R1 preferably has an angular opening delimited substantially by the intersection of two inclined planes passing respectively through each of the edges of the baffle and the centre O or the top edge O′ of the first light source S1.

### BRIEF DESCRIPTION OF THE DRAWINGS

The invention will be described hereafter with the help of a non-limiting example illustrated by the following figures:

FIG. 1 is a schematic section of a headlight according to the invention through a vertical plane passing through the optical axis.

FIG. 2 is an oblique schematic view of the headlight according to FIG. 1.

FIG. 3 is another, front, view of the headlight according to FIG. 1.

FIG. 4 illustrates the beam pattern of the first beam produced by the ellipsoidal reflector.

FIGS. 5a, 5b, 5c, 5d break down the beam pattern of the second beam produced mostly by the verticalised reflector.

FIG. 6 illustrates the beam pattern of the second complete beam.

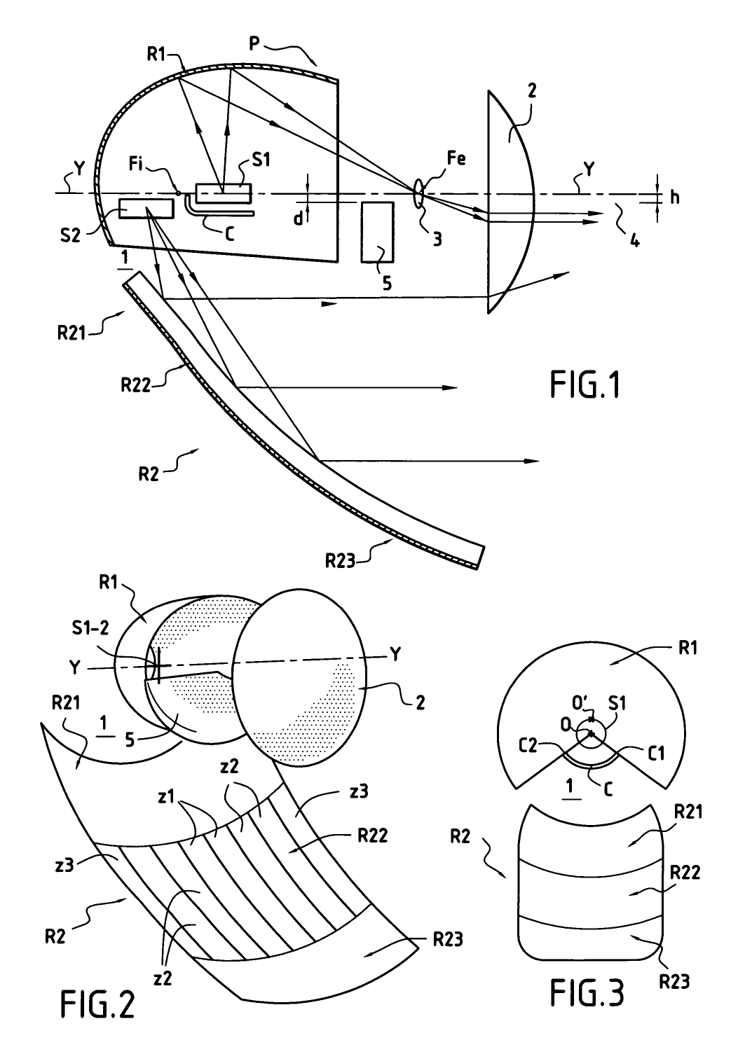

FIGS. 1, 2 and 3 are schematic and are not necessarily to scale, for more clarity.

### DETAILED DESCRIPTION OF THE INVENTION

Referring to FIGS. 1, 2 and 3, a headlight P can be seen for a motor vehicle comprising a dual filament lamp of the H4 type, comprising a first filament (the first source) S1 provided with a baffle C, and a second filament (the second source) S2. The two filaments are both assimilated, for reasons of simplification, to sources of cylindrical shape. The source S1 is placed in the vicinity and in front of the internal focus Fi of an ellipsoidal reflector R1. “Ellipsoidal reflector” means a reflector whose surface is defined from two foci, respectively an internal focus Fi and an external focus Fe, this surface approaching an ellipsoid without necessarily being exactly an ellipsoid. The surface S2 is also placed in the vicinity of the internal focus Fi but at the rear of it. The orientation of the two sources is parallel to the optical axis (YY). The source S2 is in a horizontal plane situated a little below the optical axis (YY), the source S1 is preferably situated in the horizontal plane passing through the optical axis (YY). The baffle C1 is disposed, as depicted in FIG. 3, so that its two edges C1, C2 are disposed symmetrically with respect to the vertical.

The wall of the ellipsoidal reflector R1 comprises a cut out 1 on one side of the plane passing through the optical axis Y-Y. The cut out 1 corresponds substantially to a cross-section passing through the edges C1, C2 of the baffle C and the median axis of the filament S1, through the point 0 (or, in approximation or alternatively) the axis passing through the top edge O′ of the said filament. These cutting planes are inclined by ±7.5°. This angle value, in this example 7.5°, may vary by a few degrees, in particular according to the type of baffle used. The cut out 1 is provided for letting pass downwards, on the opposite side to the major part of the reflector R12, a maximum amount of light emitted by the filament S2 towards verticalised reflector R2.

The optical axis of the ellipsoidal reflector R1 is merged with the optical axis Y-Y of the headlight.

A lens 2, with its optical axis parallel to or merged with the axis Y-Y, is placed in front of the reflector R1 in the direction of propagation of the light. The diameter of the lens 2 may be approximately 50 mm. The lens 2 is preferably of short extension (“extension” means the distance between the lens and the external focus Fe of R1). The invention also applies to lenses of greater diameter, 60 or 70 mm.

The focus 3 of the lens 2 is adjacent to or merged with the external focus Fe of the reflector R1. The focus 3 of the lens is preferably situated behind the external focus Fe of the lens 2 by a distance d, in particular approximately 1.5 mm.

Advantageously, the optical axis 4 of the lens 2 is situated lower than the optical axis Y-Y. In particular the vertical distance h between the optical axis 4 of the lens 2 and the optical axis Y-Y is approximately 1.5 mm, which makes it possible to recover more light flux coming from the reflector R1.

The accessory elements of the headlight, in particular the closure glass and auxiliary equipment for holding the reflector, lens, light source and other parts, are not shown since they are known per se.

In the case depicted in FIGS. 1 to 3, the headlight P is designed to be dual function, dipped/main beam.

The dipped function, that is to say the passing beam, is generated by the light emitted by S1, reflected by R1 and then passing through the lens 3. To obtain the required cut-off, a shield 5 is disposed between S1 and the lens 3 able to intercept part of the light reflected by the reflector R1. This shield 5 is disposed in the vicinity of the external focus Fe. The shield 5 consists of an opaque plate, for example metallic, held by any suitable means. Because of the curvature of the field, the shield 5 is planar, and has a profile corresponding to the image reversed with respect to the horizontal of the cut-off required. Advantageously, the top edge of the shield 5 is situated below the horizontal plane passing through Y-Y, at a distance d of approximately 1 mm. The dimensions of the shield are at most equal to the horizontal opening of the ellipsoid of the reflector R1.

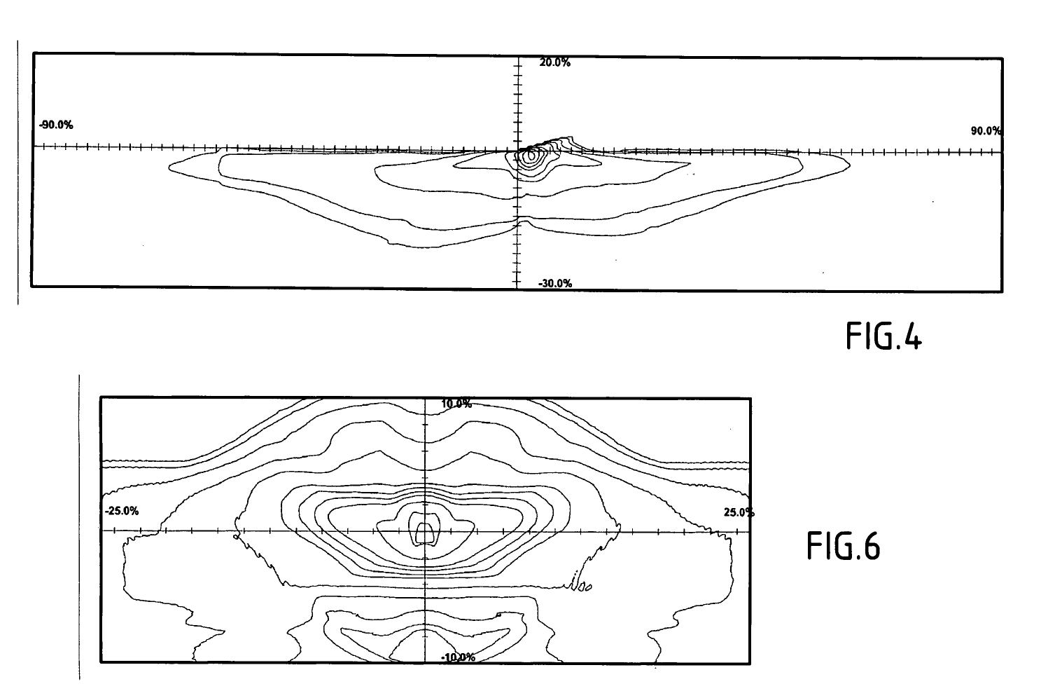

When the source S1 is switched on, the headlight therefore emits a dipped beam according to the current European and American regulations, that is to say with a cut-off in a V inclined at 15°. FIG. 4 depicts the isolux curves of the dipped beam, measured at 25 meters from the vehicle equipped with the headlight.

The verticalised reflector R2 is disposed on the side of the cut out 1 opposite to the major part of the ellipsoidal reflector R1. The intersection of this verticalised reflector R2 by a vertical plane passing through the axis Y-Y consists firstly of an arc of a curve close to an arc of a parabola having a focus close to the internal focus Fi for the approximately bottom two-thirds of this reflector (corresponding to zones R22 and R23), and secondly by a curve close to an ellipse for the top third (corresponding to the zone R21) of this reflector.

The verticalised reflector R2 is designed to give images of the source S2 centred on the optical axis (Y-Y) at infinity, that is to say, in the automobile field, a distance of several tens of metres from the vehicle equipped with the headlight.

In addition, the verticalised reflector R2 is designed to concentrate the beam that it reflects in a beam angle of no more than or around ±15° on each side of the optical axis Y-Y.

This verticalised reflector comprises:
a first zone R21 which is a reflective surface of the ellipsoidal type;
a second zone R22, which consists of two central facets z1, four intermediate facets z2 distributed on each side of the central facets, and finally two lateral facets z3 distributed on each side of the intermediate facets; and
a third zone, the lowest, R23, which is a surface of a parabolic type.

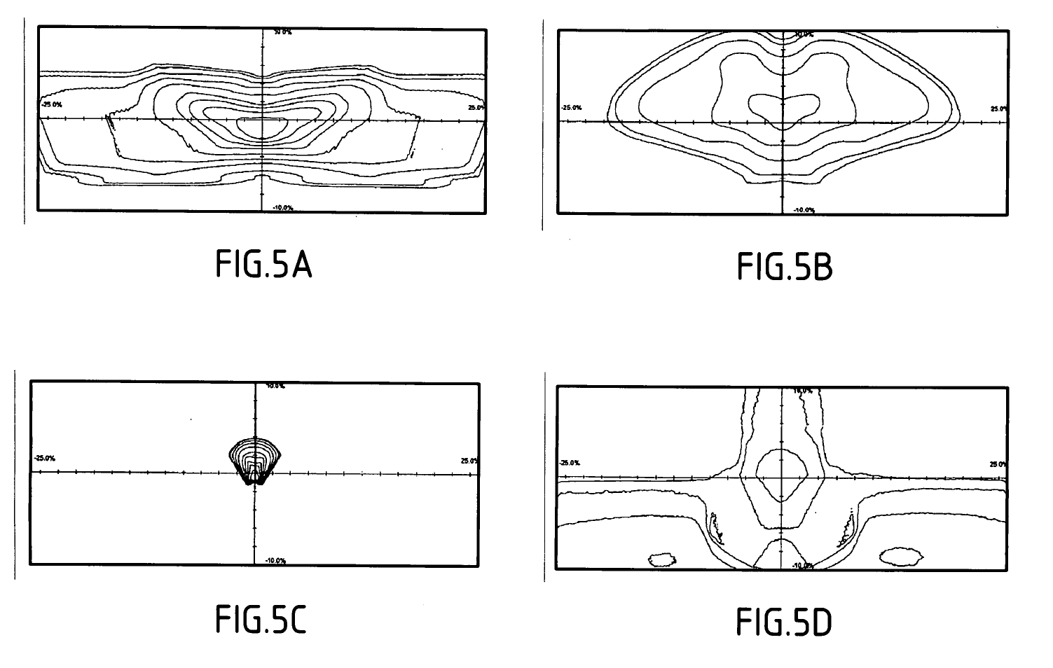

This association of three zones recovers the light emitted by the filament S2 in order to produce a beam without cut-off of the main beam type. For example, the zones R22 and R23 can constitute approximately ⅔ of the height of the reflector R2, and the zone R12 constitutes approximately ⅓ of the said height. FIGS. 5 and 6 illustrate how each zone of the verticalised reflector participates in the construction of the complete main beam: FIG. 3 is the complete main beam, which complies with European regulations. It consists of the superimposition of the partial beams depicted in FIG. 5:
FIG. 5a depicts the isoluxes of the rays emitted by S2 and then reflected by the second zone R22 of the verticalised reflector R2. It can be seen that this reflector portion contributes all at the same time to the width, to the range and to the maximum main beam required.
FIG. 5b depicts the isoluxes of the rays emitted by S2 and then reflected by the first zone R2 of the reflector R2. It can be seen that this reflector portion contributes to the comfort and range of the beam.
FIG. 5c depicts the isoluxes of the rays emitted by S2 and then reflected by the third zone R23 of the reflector R2. It can be seen that it contributes in particular to reaching the maximum required on the road.
Finally, FIG. 5d depicts the isoluxes of the rays emitted by S2 and reflected by R1. These rays are in terms of minority light fluxes, but they can also participate in the main beam, knowing however that the surface of R1 remains designed for a beam of the dipped type.

The invention applies not only to a headlight able to produce two beams of the dipped/main beam type, but also to any combination of two functions. It makes it possible to switch easily from one function to another by switching on one or other of the filaments, without having to tilt a shield, without any movement of mechanical parts, which is very advantageous in terms of reliability and compactness.

1. A lighting device for a motor vehicle of the headlight type comprising at least one reflector and one light source and able to emit several different light beams, wherein:
(a) a first light source having a direct shield, the first light source in the vicinity of and in front of the internal focus of an ellipsoidal reflector, in particular so that the axis of the source is substantially parallel to the optical axis of the ellipsoidal reflector, the ellipsoidal reflector being designed to produce a first beam from the first source;
(b) a second light source in the vicinity of and behind the internal focus of the ellipsoidal reflector, in particular so that the axis of the source is substantially parallel to the optical axis of the ellipsoidal reflector;
(c) a wall of the ellipsoidal reflector comprising a cut out situated on one side of a plane, in particular a plane that is substantially horizontal when the device is in the mounted position in the vehicle;
(d) a lens with the optical axis substantially parallel to or merged with that of the ellipsoidal reflector, the lens being in front of the ellipsoidal reflector, the focus of the lens being adjacent to the external focus of the ellipsoidal reflector; and
(e) a verticalised reflector disposed on the side of the cut out opposite to the major part of the ellipsoidal reflector, the verticalised reflector being designed to produce, from the second source housed in the ellipsoidal reflector, a second light beam which is not substantially intercepted by the lens.

2. The lighting device according to claim 1, wherein the verticalised reflector comprises at least three zones disposed successively up the height of the reflector:
(a) a first zone, closest to the cut out, which is an ellipsoidal surface portion;
(b) a second zone composed of a plurality of facets; and
(c) a third zone which is a parabolic surface portion.

3. The lighting device according to claim 1, wherein the two light sources are combined in a single lamp of the dual filament type.

4. The lighting device according to claim 2, wherein the first zone of the verticalised reflector is an ellipsoidal surface focussed on the second light source.

5. The lighting device according to claim 2, wherein the second zone of the verticalised reflector comprises a plurality of facets essentially oriented at the height of the verticalised reflector.

6. The lighting device according to claim 5, wherein the second zone of the verticalised reflector comprises at least one central facet, at least two intermediate facets and at least two lateral facets.

7. The lighting device according to claim 2, wherein the beam produced by the third zone helps to define the maximum of the beam produced by the whole of the verticalised reflector.

8. The lighting device according to claim 1, wherein the ellipsoidal reflector comprises a shield situated in the vicinity of the external focus of the reflector so that the beam coming from the reflector and emitted by the device is a beam with cut-off, in particular of the dipped type.

9. The lighting device according to claim 8, wherein the shield is associated with an additional optical element disposed between the light source and the shield, the additional optical element being in the vicinity of the optically active edge of the shield and having at least one reflective surface able to redirect, above the optically active edge of the shield, light rays emitted by the source in the direction of the shield.

10. The lighting device according to claim 1, wherein the second beam coming from the second source and reflected by the verticalised reflector, possibly with a contribution from the ellipsoidal reflector, is a beam without cut-off of the main beam type.

11. The lighting device according to claim 1, wherein the axis of at least one of the light sources, in particular of the two sources, is disposed in a substantially horizontal plane.

12. The lighting device according to claim 2, wherein all the zones of the verticalised reflector have a focus situated in the vicinity of the second light source.

13. The lighting device according to claim 1, wherein the beam produced by the verticalised reflector has a beam angle of no more than around 15° on each side of the optical axis.

14. The lighting device according to claim 1, wherein the beam produced by the ellipsoidal reflector has a beam angle of approximately 35° to 40° on each side of the optical axis.

15. The lighting device according to claim 1, wherein the plane passing through the axis of one of the light sources is substantially horizontal, the ellipsoidal reflector being situated above the plane and the verticalised reflector being situated below the plane.

16. The lighting device according to claim 1, wherein the cut out of the ellipsoidal reflector has an angular opening delimited substantially by the intersection of two inclined planes passing respectively through each of the edges of the direct shield and the center or the top edge of the first light source.

17. The lighting device according to claim 1, wherein the light sources comprise dual filament lamp of the H4 or DFCS type.

18. The lighting device according to claim 1, wherein it is a dual function dipped/main beam optical module.
